(19) United States
(12) Patent Application Publication
(10) Pub. No.: US 2024/0394946 A1
(43) Pub. Date: Nov. 28, 2024

(54) SYSTEM AND METHOD FOR CREATING CUSTOMIZED FORMS WITH ANIMATED OBJECTS

(71) Applicant: Easy WebContent, Inc. DBA Visme, Rockville, MD (US)

(72) Inventor: Payman Taei-Tehrani, Potomac, MD (US)

(21) Appl. No.: 18/671,183

(22) Filed: May 22, 2024

Related U.S. Application Data
(60) Provisional application No. 63/469,169, filed on May 26, 2023.

(51) Int. Cl. G06T 13/40; G06T 19/20

(52) U.S. Cl. CPC G06T 13/40; G06T 19/20; G06T 2219/2012; G06T 2219/2016; G06T 2219/2024

(57) ABSTRACT

An embodiment includes a system implementable on a computing device having one or more processors and one or more memories. The system includes a visual design system to generate a single visual data structure based on a hierarchy of components. An embodiment allows customers to create animated forms on their websites, enhancing user engagement and interaction. An aspect of the embodiment is the ability to choose from a selection of characters and gestures, customize the character's appearance, and select from various animated poses and gestures available, providing users with the flexibility to customize the appearance of the animated forms.

### CROSS-REFERENCE TO RELATED APPLICATIONS

This application claims priority to U.S. Provisional Patent Application Ser. No. 63/469,169, entitled “System and Method for Creating Customized Forms with Animated Objects” and filed on May 26, 2023, the disclosure of which is incorporated herein by reference in its entirety.

### TECHNICAL FIELD

An embodiment of the present invention pertains to the field of online customer interaction and feedback systems and to the utilization of animated characters and gestures to enhance user engagement and interaction. More specifically, an embodiment enables customers to create customized animated web forms with unique designs, animated characters, and branding elements (e.g., for their websites, in an email, shared as a link or in social media, etc.), thereby facilitating the collection of customer feedback and contact information in an engaging and interactive manner for the purpose of increasing conversion rates and improving audience engagement.

### BACKGROUND

Online businesses often rely on web forms as a manner of communication with potential customers and prospects, allowing visitors to submit queries, feedback, and requests for information. However, traditional online forms are often static and uninviting, leading to reduced engagement and conversion rates. Website owners and brands have attempted to address this issue by creating custom forms that are more visually appealing and engaging. However, this process can be time-consuming and require specialized skills that many website owners may not possess. Additionally, custom forms may lack the dynamic and interactive elements that are essential for engaging today's online audience. Despite the availability of various systems and tools for creating traditional online forms, there remains a need for a more user-friendly and intuitive system that allows for a more personable interactive experience without requiring extensive technical knowledge.

Moreover, existing approaches for collecting viewer/user feedback and contact forms on websites exhibit certain missing functionalities and limitations that hinder the ability to provide a truly engaging user experience. These approaches predominantly offer static forms or conventional animated ones that lack the ability to capture user attention or foster active user participation. Conventional animated forms contain only an animated background and do not have customized animated characters, gestures, or other graphical objects. Additionally, there is a lack of options for customizing the appearance, such as animation style, characteristics of graphical objects, such as clothes and apparel, animation styles and gestures, and output of the forms to align with an individual's desired branding needs.

A significant missing functionality in existing approaches is the lack of animated characters or gestures in online forms. Current approaches do not provide the ability to seamlessly integrate animated characters or gestures into online forms, limiting the potential for enhanced user experience and interaction.

### SUMMARY

An embodiment of the present invention includes a system implementable on a computing device having one or more processors and one or more memories. The system includes a visual design system to generate a single visual data structure based on a hierarchy of components. The embodiment of the present invention improves the functioning of the computer by accelerating the achievement of the desired result and increasing the efficiency for customer feedback, signup forms, lead generation forms, contact forms, registration forms, login forms, subscription forms, feedback forms, order forms, survey forms, application forms, rsvp forms, comment forms, donation forms, file upload forms, booking forms, search forms, newsletter signup forms, social media sharing forms, request forms, suggestion forms, and other forms by introducing an approach that utilizes animated characters or gestures. Unlike conventional static forms, the embodiment allows customers to create animated forms on their websites, enhancing user engagement and interaction. An aspect of the embodiment includes the ability to choose from a selection of characters and gestures, customize the character's appearance, and select from various animated poses and gestures available, thereby providing users with the flexibility to customize the appearance of the animated forms.

Further, an embodiment of the present invention enables customers to create customized animated forms quickly and easily without the need for extensive technical expertise. The term customer includes, but is not limited to, clients, website owners, businesses, organizations, companies, individuals, freelancers, e-commerce platforms, bloggers, marketing agencies, service providers, content creators, etc. The embodiment provides a user-friendly interface that allows the user to customize each step of the animation script according to their preferences and branding. By doing so, customers can create unique forms that stand out from pre-made templates. This eliminates the need for complex coding and design work, making it easier for customers to create visually appealing forms that suit their needs.

An embodiment of the present invention enhances the form-filling process to captivate the viewer's attention. An animated character is introduced alongside the form, creating an engaging visual presentation that directs or assists entry of information in the form. This character may also interact with the form, enhancing the user experience. By incorporating animated elements into the form-filling stage, the embodiment immediately grabs the viewer's attention and sets the stage for an immersive and interactive experience.

Moreover, an embodiment of the present invention offers the potential for increased engagement through interactions between the animated character (e.g., which can be humanoid or non-humanoid, can be hand signals or gestures, etc.) and the viewer. Although the interaction of the animated character with the viewer occurs throughout the entire process of filling out the form: when the form appears on the viewer's screen, the animated character appears next to the form and interacts with the form; during the filling of the form, the animated character may engage with the viewer about how the form is filled, and interacts with gestures and movements. This development enhances user experience and fosters a deeper level of engagement, thereby creating a memorable interaction for the user and increasing engagement and conversion rates for customers.

An embodiment of the present invention offers a range of pre-made templates for forms, which can be easily identified or found based on keywords and/or categories, and modified to suit the customer's needs. A system provides flexibility in modifying each step of an animation script, for example, the choice of options for the appearance of graphical objects, the interaction of graphical objects with the form, the interaction of graphical objects with the user, the interaction of forms with the user, ensuring that the resulting contact form is unique and engaging despite being created from pre-made templates (e.g., indicating information for an initial layout of the form). By allowing customers to create animated forms that are tailored to their brand identity and preferences, the embodiment empowers the customers to create a powerful online presence that sets them apart from their competitors.

Further, an embodiment of the present invention allows for easy integration of the created forms into websites by providing the option to generate computer or other code for the form (e.g., via a code generation module). This code can be easily copied and pasted into the website's codebase, making it a straightforward process for customers to incorporate animated forms into their websites.

An embodiment of the present invention uses advanced technology to ensure that the forms created are optimized for increased engagement and conversion rates. The embodiment also allows for the automatic collection and synchronization of all data and contacts collected through the form directly into other applications. This feature eliminates the need for manual data entry, providing customers with more time to focus on other areas of their website.

An embodiment of the present invention provides detailed statistics or metrics on the performance of the form. This includes information on the date, user email, user device, completion time, conversion rates, and other metrics, allowing customers to optimize their forms for maximum performance.

In addition, an embodiment of the present invention offers an approach to creating animated contact forms (e.g., for their websites, in an email, shared as a link or in social media, etc.) that utilizes animated characters or gestures to enhance user engagement and interaction. The ability to select from a variety of characters and customize their appearance, along with a wide range of animated poses and gestures, provides users with a unique and powerful tool for capturing customer feedback and contact information. The embodiment of the present invention provides customers with the flexibility and customization options they need to create unique forms that stand out and improve conversion rates. The automatic collection and synchronization of data, along with detailed statistics, make the embodiment a useful tool for any customer looking to improve their online presence.

### BRIEF DESCRIPTION OF THE DRAWINGS

A clear understanding of the features of embodiments of the present invention may be had by reference to the drawings, which illustrate the embodiments of the invention, although it will be understood that such drawings depict preferred embodiments of the invention and, therefore, are not to be considered as limiting its scope with regard to other contemplated embodiments of the present invention. Generally, like reference numerals in the various figures are utilized to designate like components. Accordingly:

FIG. 1A is an illustration of a system for creating animated forms according to an embodiment of the present invention.

FIG. 1B is an illustration of a flow diagram for creating animated forms according to an embodiment of the present invention and showing work of a backend in a process of customization of a form by a customer.

FIG. 1C is an illustration of a flow diagram for creating animated forms according to an embodiment of the present invention showing work of a backend in a process of filling out a form by a user.

FIG. 1D is an illustration of a 3D modeling and animation flowchart in a process of customization of a form by a customer according to an embodiment of the present invention.

FIG. 1E is an illustration of a flow diagram of rendering and displaying animated objects according to an embodiment of the present invention.

FIG. 2 is an illustration of a dialog box for creating a form in which a client specifies for what purposes the form will be used according to an embodiment of the present invention.

FIG. 3 is an illustration of a dialog box for creating a form in which a client specifies where this form will be used according to an embodiment of the present invention.

FIG. 4 is an illustration of a dialog box for creating a form in which a client selects fields to be displayed in the form according to an embodiment of the present invention.

FIGS. 5A-5B are illustrations of a user interface showing further customizing a form in a process of its creation, including: choosing a predefined form design style, adding a new style, choosing an animation character, detailed customization of such a character, an ability to preview the selected customization settings, an ability to add sound effects, and choosing an animation from a library of available animations options according to an embodiment of the present invention.

FIG. 6 is an illustration of a user interface showing deeper customization of text style and graphical object appearance according to an embodiment of the present invention.

FIG. 7A is an illustration of a user interface showing deeper customization of a character's head appearance with glasses, brows, nose, and lips according to an embodiment of the present invention.

FIG. 7B is an illustration of a graphical object of gestures according to an embodiment of the present invention.

FIG. 8 is an illustration of a user interface showing customization of a graphical object (in the case of the graphical object being a character) with respect to clothing according to an embodiment of the present invention.

FIG. 9 is an illustration of a user interface showing animation of an appearance and interaction of a graphical object with a form according to an embodiment of the present invention.

FIG. 10 is an illustration of a user interface showing advanced form creation logic of animation according to an embodiment of the present invention.

FIG. 11 is an illustration detailing a stage of advanced form creation including animation form type selection in a user interface of an advanced form creation tool according to an embodiment of the present invention.

FIG. 12 is an illustration detailing a stage of advanced form creation including animation selection in the user interface of the advanced form creation tool according to an embodiment of the present invention.

FIG. 13 is an illustration detailing a stage of advanced form creation including character and scenario selection in the user interface of the advanced form creation tool according to an embodiment of the present invention.

FIG. 14 is an illustration detailing a stage of advanced form creation including segment configuration in the user interface of the advanced form creation tool according to an embodiment of the present invention.

FIG. 15 is an illustration detailing a stage of advanced form creation including segment animation selection in the user interface of the advanced form creation tool according to an embodiment of the present invention.

FIG. 16 is an illustration detailing a stage of advanced form creation including changing steps or operations of the animated form and accompanying animation in the user interface of the advanced form creation tool according to an embodiment of the present invention.

FIG. 17 is an illustration detailing a stage of advanced form creation including animation of an error and a step back in a process for filling out a form, and also illustrates animation sequence logic in the user interface of the advanced form creation tool according to an embodiment of the present invention.

FIG. 18 is an illustration of the user interface of the advanced form creation tool for editing a plot, scene, steps, fields for filling out a form, and animations according to an embodiment of the present invention.

FIG. 19 is an illustration of the user interface of the advanced form creation tool for editing movement, a waiting pose, and an ending pose according to an embodiment of the present invention.

FIG. 20 is an illustration of the user interface of the advanced form creation tool for previewing a form and choosing a movement animation according to an embodiment of the present invention.

FIG. 21 is an illustration of the user interface of the advanced form creation tool for customizing content of a form and form fields according to an embodiment of the present invention.

FIG. 22 is an illustration of a user interface showing publication and sharing according to an embodiment of the present invention.

FIG. 23 is an illustration of a user interface showing setting of privacy parameters according to an embodiment of the present invention.

FIG. 24 is an illustration of a user interface showing published form statistics according to an embodiment of the present invention.

### DETAILED DESCRIPTION

The terminology used herein is for the purpose of describing particular embodiments only and is not intended to limit the present invention. As used herein, the term “and/or” includes any and all combinations of one or more of the associated listed items. As used herein, the singular forms “a,” “an,” and “the” are intended to include the plural forms as well as the singular forms unless the context clearly indicates otherwise.

It will be further understood that the terms “comprises”, “comprising”, “includes”, “including”, “have”, “having” and the like specify the presence of stated features, steps, operations, elements, and/or components but do not preclude the presence or addition of one or more other features, steps, operations, elements, components, and/or groups thereof.

It will be further understood that the term “form” may include customized interactive animated web forms used both on websites and via links, email, and/or social media, including, but not limited to, signup forms, contact forms, registration forms, login forms, subscription forms, feedback forms, order forms, survey forms, application forms, comment forms, donation forms, file upload forms, booking forms, search forms, newsletter signup forms, social media sharing forms, request forms, suggestion forms.

It will be further understood that the term “graphical object” may include characters (e.g., people, animals, etc.), images, avatars, gestures (e.g., by any body parts or objects, etc.), etc.

It will be further understood that the term “customer” may include prospect, clients, website visitors, businesses, organizations, companies, individuals, freelancers, e-commerce platforms, bloggers, marketing agencies, service providers, content creators, etc.

Unless otherwise defined, all terms (including technical and scientific terms) used herein have the same meaning as commonly understood by one having ordinary skill in the art to which embodiments of this invention belong. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the embodiments of the present invention, it will be understood that a number of techniques and steps or operations are disclosed. Each of these has individual benefits, and each can also be used in conjunction with one or more, or in some cases all, of the other disclosed techniques. Accordingly, for the sake of clarity, this description will refrain from repeating every possible combination of the individual steps or operations in an unnecessary fashion.

Nevertheless, the specification and claims should be read with the understanding that such combinations are entirely within the scope of the present invention and the claims.

In the following description, for purposes of explanation, numerous specific details are set forth in order to provide a thorough understanding of the embodiments of the present invention. It will be evident, however, to one skilled in the art that the embodiments of the present invention may be practiced without these specific details.

The present disclosure is to be considered to provide example embodiments of the present invention and is not intended to limit the present invention to the specific embodiments illustrated by the figures or description below.

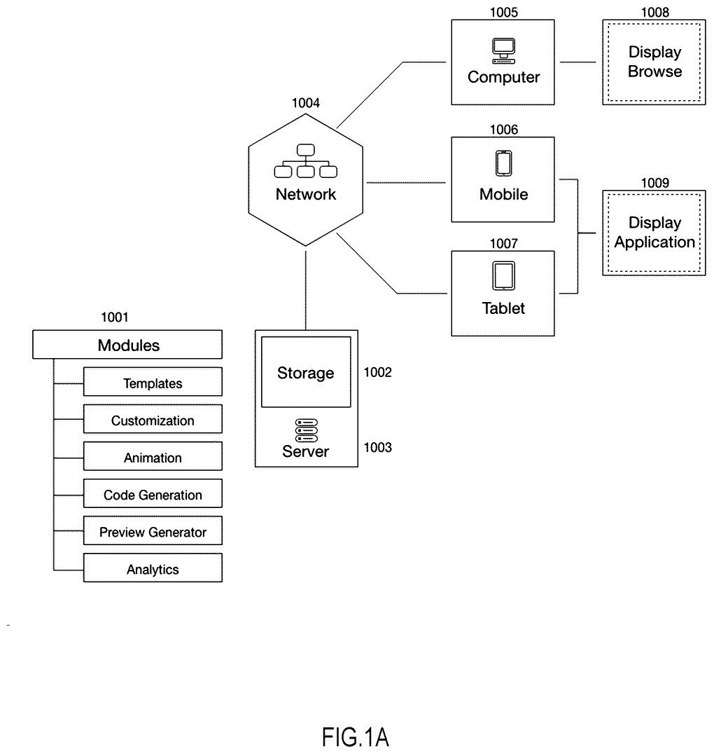

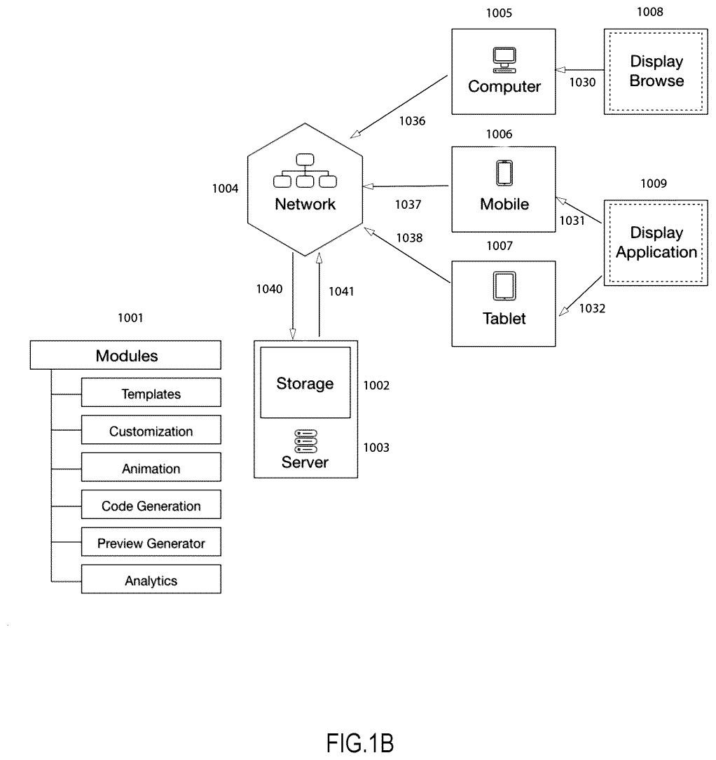

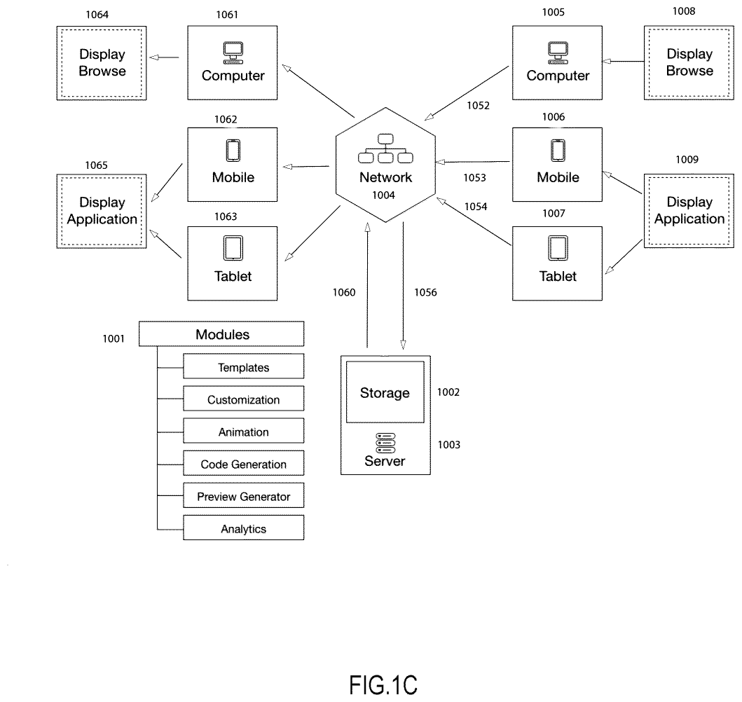

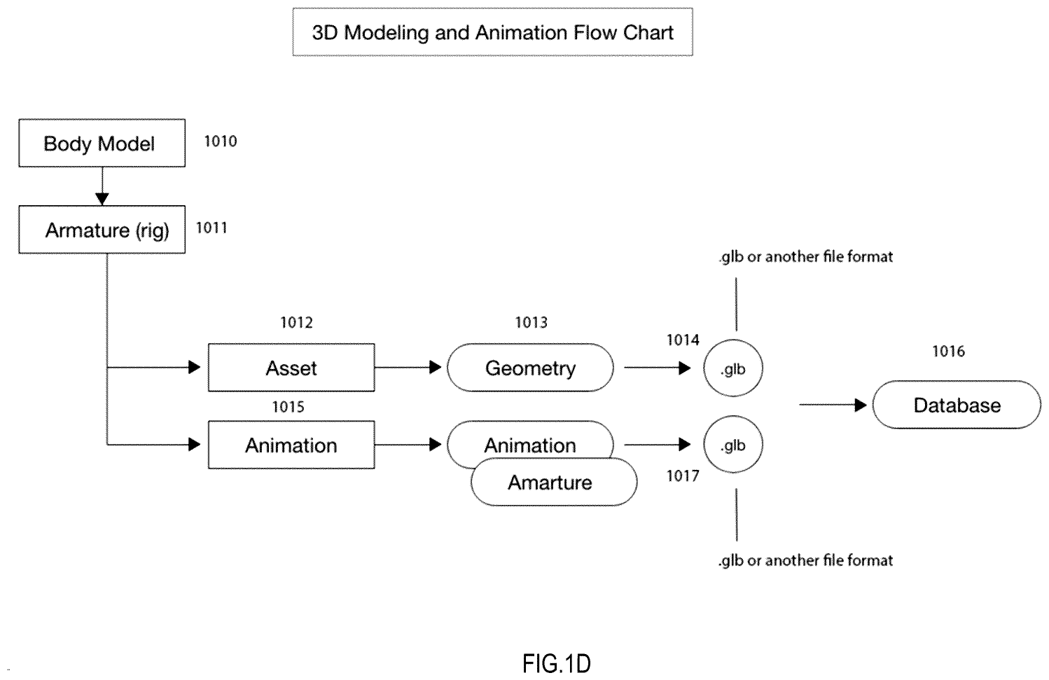

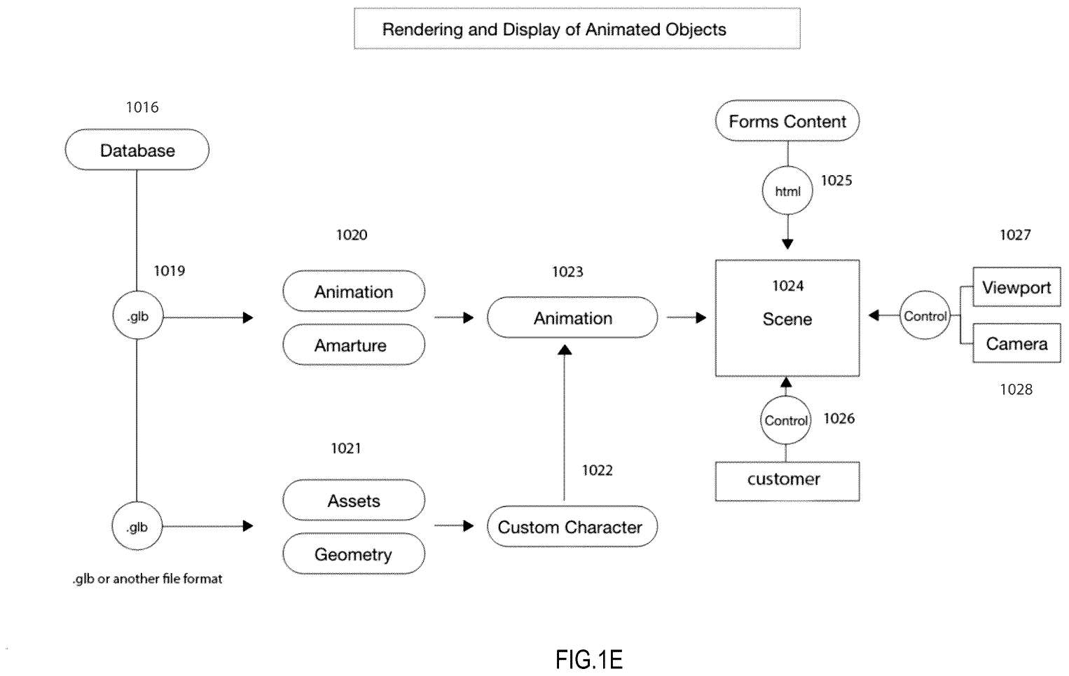

FIG. 1A is a system diagram of a system configured to create forms with animation according to an embodiment of the present invention. The system makes use of a server 1003 that stores, in a storage 1002, system modules 1001, such as templates, customization, animation, code generation, preview generator, and analytics modules. The server is connected to a network 1004 through which user devices, such as computer 1005, mobile device 1006, and tablets 1007, can connect. A browser 1008 is used to access the system when the connection is made via a computer 1005. When the connection is made via a mobile device 1006 or a tablet 1007, an application 1009 can also be used in addition to the browser. After connecting through one of the devices to the server 1003, through the interface of a browser 1008 or mobile application 1009, the user sends commands to the system, which are sent to the server 1003 through the network 1004 and executed by the corresponding system module 1001. The various computing devices of present invention embodiments (e.g., server 1003, computer 1005, mobile device 1006, tablet 1007, etc.) may be implemented by any conventional or other computer systems preferably equipped with a display or monitor, a base, optional input devices (e.g., a keyboard, mouse or other input device), and any software for use by present invention embodiments. The base may include at least one hardware processor (e.g., microprocessor, controller, central processing unit (CPU), etc.), one or more memories, and/or internal or external network interfaces or communications devices (e.g., modem, network cards, etc.)).

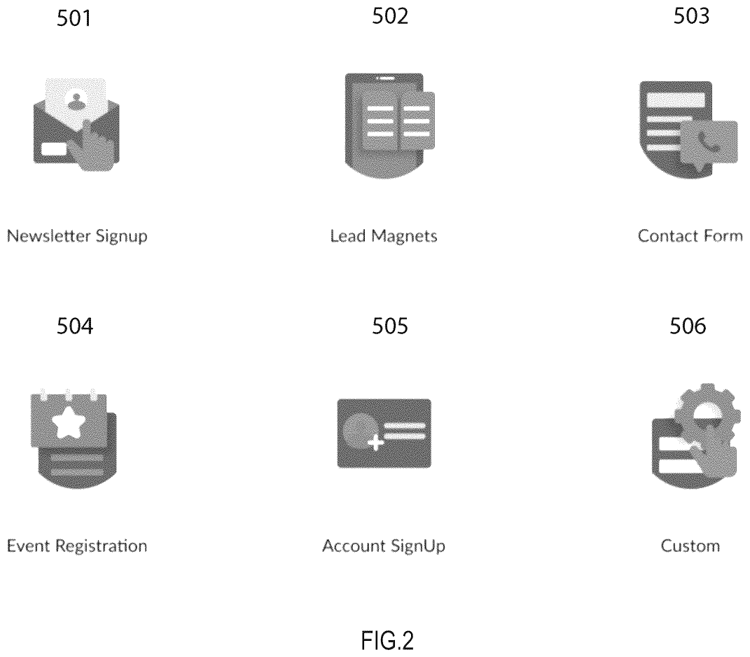

FIG. 1B is a flow diagram of an embodiment showing a customer's interaction with the system of FIG. 1A. The customer, using communications 1030, 1031, 1032 from browser 1008 or application 1009 on their device, which can be a computer 1005, mobile device 1006, or tablet 1007, through the user interface of the system (e.g., FIGS. 2-24 described below) in order to create, customize a form, or work with an already completed form, sends commands 1036, 1037, 1038 through the network 1004 to the server 1003 where the system modules 1001 are stored in storage 1002. Depending on the command type, it is executed by the corresponding system module 1001 stored on server 1003. After processing the command 1040, the corresponding module 1001 sends a response 1041 through the server 1003 and the network 1004 to the customer device, which can be computer 1005, mobile device 1006, or tablet 1007, through the user interface on the browser 1008 or application 1009. The customer device displays the results of the customer command sent in the process of creating, customizing the form, or working with an already completed form.

FIG. 1C is a flow diagram of an embodiment showing the user's interaction with the system of FIG. 1A. The user, using browser 1008 or application 1009 on their device, which can be a computer 1005, mobile device 1006, or tablet 1007, gets access to the form created by the customer and fills it with data in accordance with the settings selected by the customer. This data 1052, 1053, 1054 is sent via the network 1004 to server 1003, where it is stored in storage 1002 and processed by the corresponding system module 1001, for example, by the analytics module of system modules. User data, as well as processing results, 1060 to command 1056 are available to a customer (or form provider) through the network 1004 on their device, which can be a computer 1061, mobile device 1062, or tablet 1063, through the user interface on a browser 1064 or application 1065 and can be used for customer's purposes. Computer 1061, mobile device 1062, tablet 1063, browser 1064, and application 1065 are substantially similar to the corresponding components described above.

FIG. 1D is an example flowchart showing a backend of a three-dimensional (3D) modeling and animation process of creation and customization of the form by the customer according to an embodiment of the present invention. The process starts with the selection of a style, the geometry of a body model 1010, and a rig base 1011 which is used as the basis for the creation of multiple assets that adapt to both a geometry 1013 and the rig. The term “rig” refers to the digital skeleton or framework that is created to control the movement and deformation of a character or object. Animation 1015 is the result of the individual movement of each bone of the skeleton approximately 24 times per second (e.g., in a range of 10-30 times) on a timeline. This movement is registered and applied to the characters that are the union of several assets linked to the respective bones of the rig 1011. Assets 1012 (e.g., hair, clothes, accessories, etc.) are exported at operation 1014 using the geometry information of a body model 1010, and the animation 1015 is exported at operation 1017 using the armature (rig) information and the animated gestures. Then, both the multiple exported assets 1012 and the exported animation 1015 in .glb or another file format are stored in a database 1016 hosted on the server. Animation 1015 requires assets 1012 (geometry) to be displayed, and the assets 1012 requires the rig 1011 to render the complete animation.

FIG. 1E is an example flow diagram of a backend of rendering and displaying animated objects according to an embodiment of the present invention. Exported assets and the exported animation stored in a database 1016 in .glb 1019 or another file format as described above (FIG. 1D) are requested from the storage hosted on the server for further rendering. Next, assets with geometry 1021 and animation 1020 (from database 1016) are customized with separate assets according to the customer's preferences. The process of animation 1023 and customization 1022 takes place in a scene 1024 of a window on the screen of the customer's computer, mobile device, or tablet. Scene 1024 may be a JavaScript library for creating and displaying three-dimensional (3D) computer graphics in web browsers. In addition to graphic 3D elements, HTML data 1025 of the form is loaded and rendered on the scene, for example, form fields, heading, first name, last name, email, company name, job title, bottom, and text. HTML and 3D spaces are merged on the scene, under customer control 1026, using user interface elements. As a result, the form and graphical object are animated. A viewport plane 1027 is a plane inside the scene, which helps the customer to place camera 1028 correctly, as the customer looks at the animation using camera 1028. Camera 1028 defines position, angle, and additional parameters from which to view the scene.

Referring to FIG. 2, an example is shown of a dialog box or user interface for selecting and configuring a form, which defines the purpose of creation and determines where this form will be used. In this dialog box, the customer can select one of the preset profiles or templates, including but not limited to: newsletter signup 501, which is a recommended first step in an email marketing strategy; lead magnets 502, which offer valuable content and also gather the emails of new subscribers; contact form 503 which is used to learn more about subscribers; event registration 504, which is used to pre-register for upcoming events; account SignUp 505, which is used to create a new user account; and/or custom 506, which can be configured from scratch to suit any needs of the customer. The embodiments may be used with any type of preset profiles or templates in substantially the same manner described herein. The templates may include information for an initial layout of the form (e.g., fields, animation, font, style, color, etc.) that may be modified as described below. Selecting any of the above settings, in combination with the selections made in the following form customization dialog boxes, sets certain parameters of the final form. After completing the configuration on this screen, the user proceeds to the next form configuration screen.

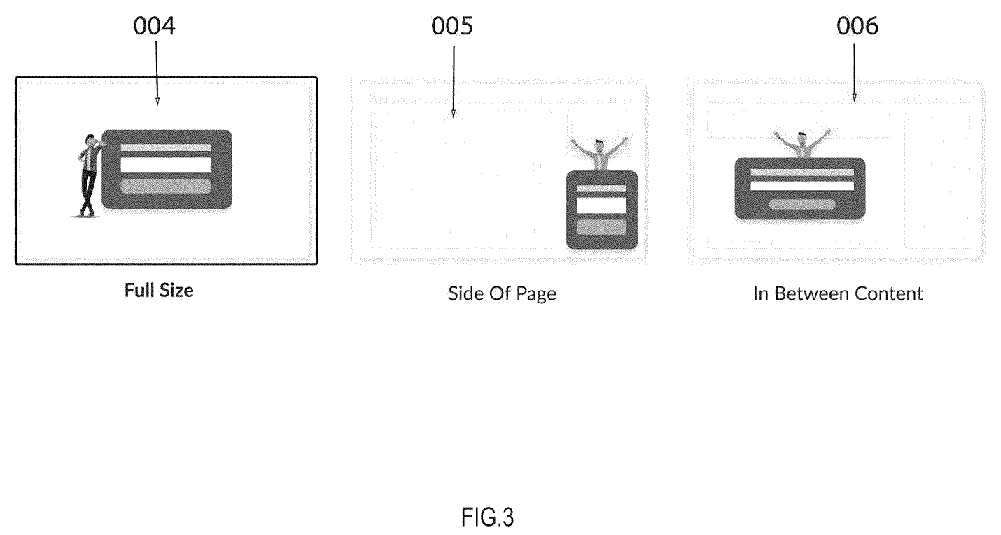

Referring to FIG. 3, an example is shown of a further dialog screen or user interface for selecting and configuring a form via corresponding actuators, which defines a place and method of placing the form on the page. This can be, for example, a full page form 004, on one side of the page 005, or in between content 006. After completing the configuration on this screen, the customer proceeds to the next form configuration screen.

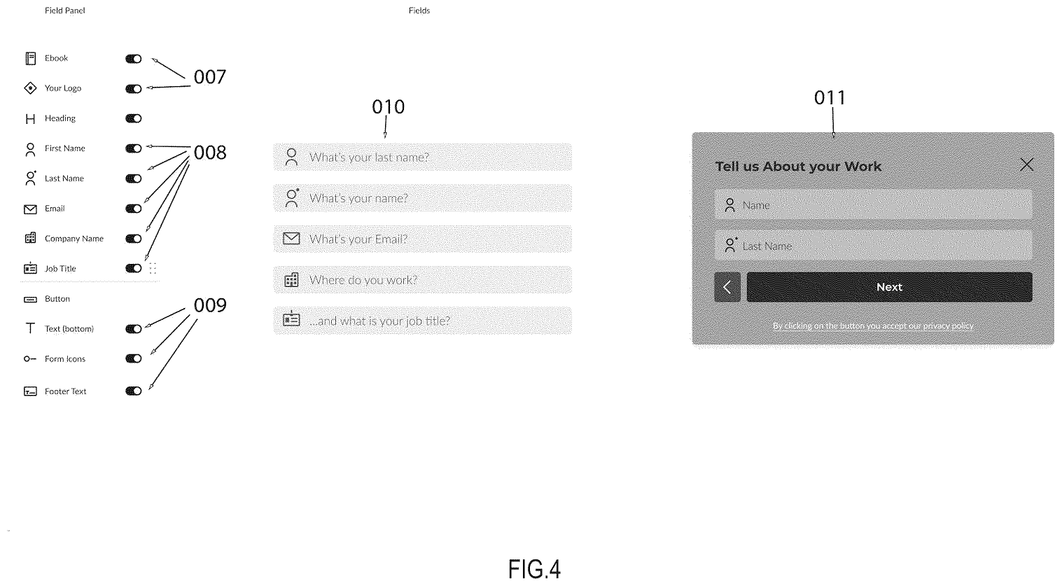

Referring to FIG. 4, an example is shown of a further dialog screen or user interface for selecting and configuring a form, which defines form composition. In the left part of the panel, there are enable and disable switches 007, 008, and 009, by which the customer can configure the composition of the form. The form may include fields and elements such as, but not limited to: logo, heading 007; first name, last name, email, company name, job title 008; bottom, text, form icons, and footer text 009. Fields may be of any type and use any input mechanisms (e.g., dropdowns, checklist, or any other form fields). Depending on the activated form fields, the selected list of fields will be displayed on screen 010, as well as the selected elements, such as form icons and footer text 011. The fields may be arranged (or re-arranged) by the user in any fashion to modify or customize the layout of the form. After completing the configuration on this screen, the customer proceeds to the next form configuration screen.

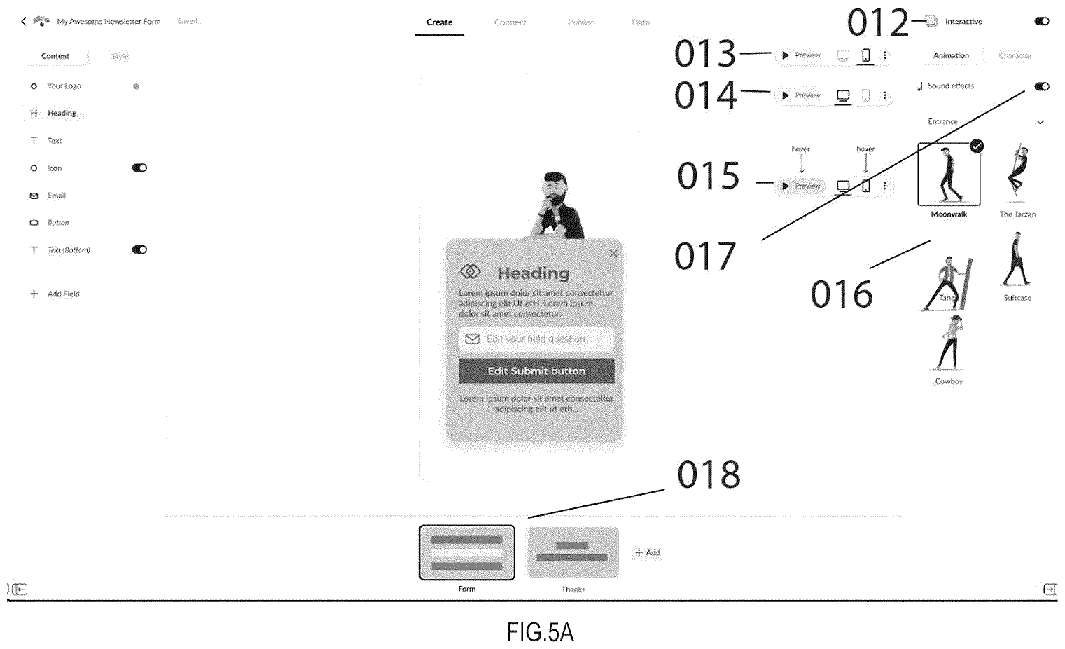

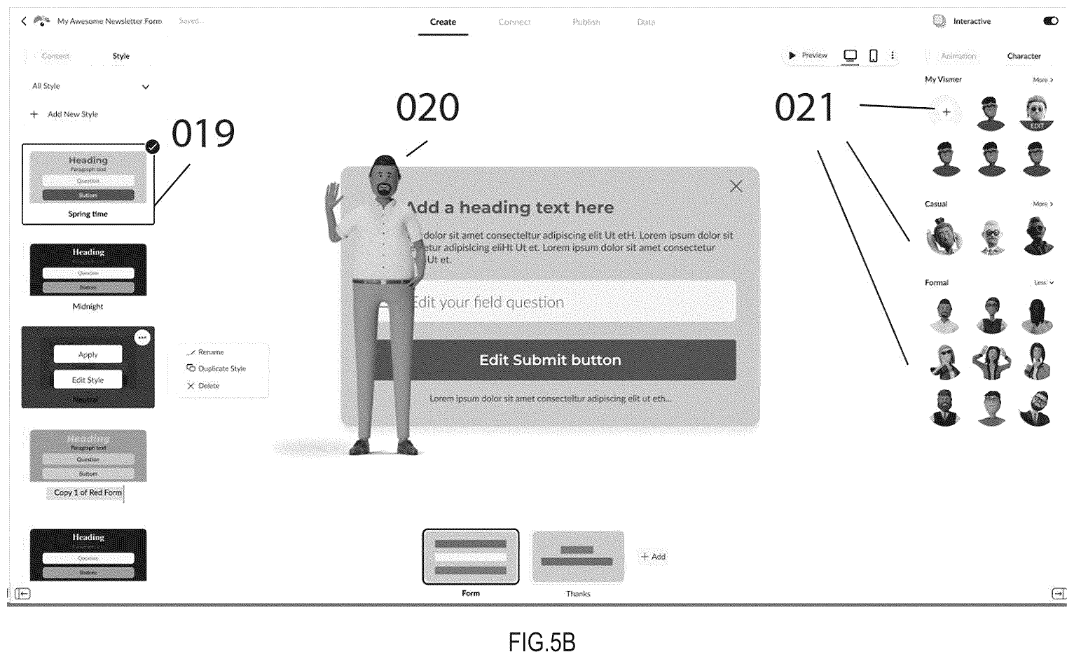

Referring to FIGS. 5A and 5B, an example is shown of a further dialog screen or user interface of configuring a form, in particular, the animation component and graphical object selection. The customer can enable a form interactivity mode 012 via a corresponding actuator. In this dialog screen, the customer will be able to add to a form, via corresponding actuators, musical accompaniment 017 and graphical object animation 016 from a library with an animation template. The animation may direct or assist entry of information into the form fields. The customer can customize the user experience flow by customizing not only the main form but also the content that will be shown to the user before and after completing an action, such as filling out a form, for example, an animated dialog box 018 saying thank you for filling out a main form. There can be several such sequential forms. The system allows the customer to make a preview of the selected form both on a mobile device in the application 013 and on a computer in a browser 014 via corresponding actuators, and enable a hover preview feature 015 via a corresponding actuator where a preview of an item or content is displayed when hovering a mouse pointer or other input mechanism over it. Another customization screen (FIG. 5B) will allow the customer to select a form style from a style library 019 to modify or customize the form layout (e.g., style, color, etc.) and make a general graphical object personalization 021 of an object 020.

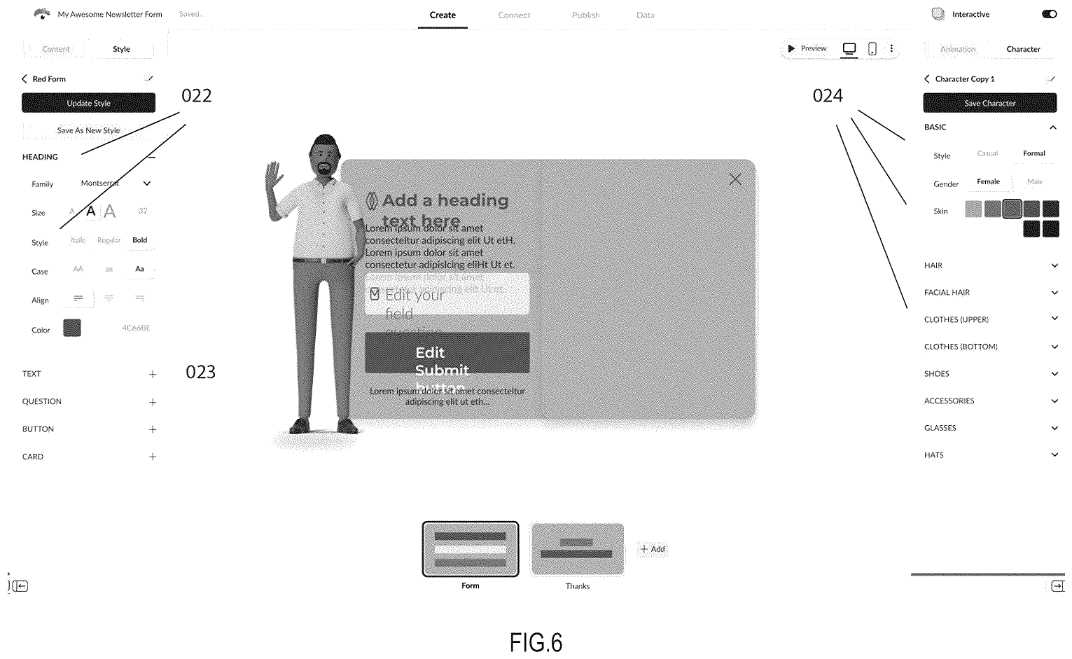

Referring to FIG. 6, an example is shown of another dialog screen or user interface of configuring a form, in particular, customization of text style and graphical object appearance. Text customization can modify the form layout, via corresponding actuators, including font family, size, style, case, align, and color 022. Additional text customizations can include a question, button, and/or card 023 added to a form. The graphical object, for example, in the case of a character (e.g., person, animal, etc.), can additionally be configured via corresponding actuators with style, gender, skin tone, hair, facial hair, clothes (upper), clothes (bottom), shoes, accessories, glasses, and/or hats 024.

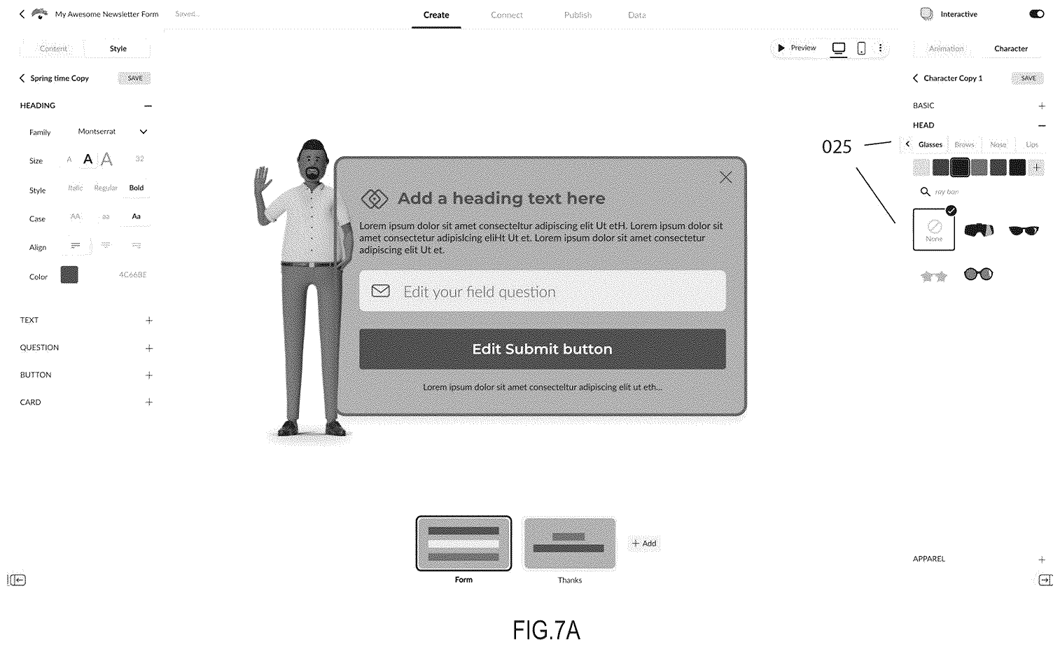

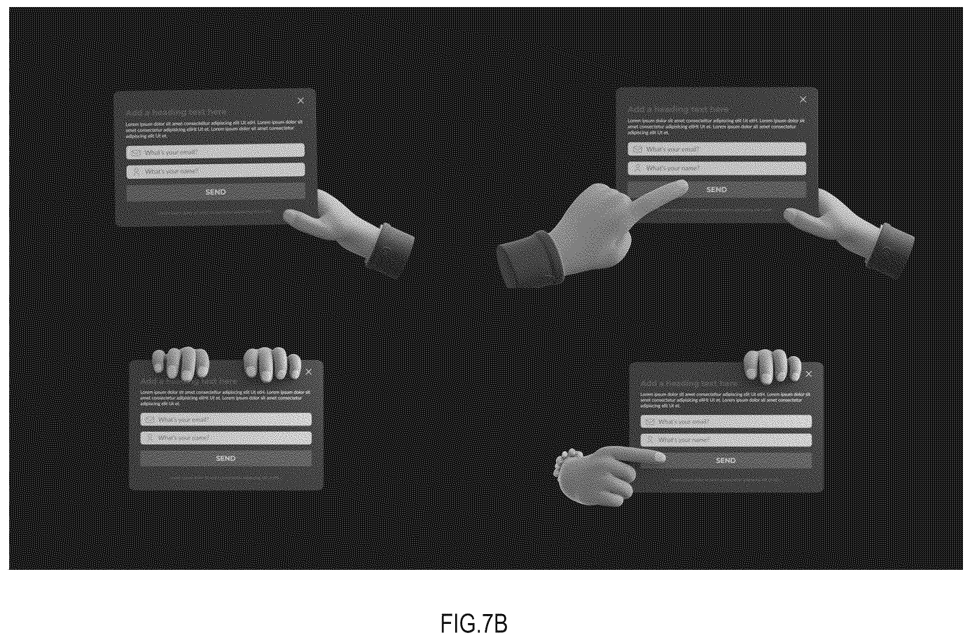

Referring to FIG. 7A, an example is shown of another dialog screen or user interface of configuring a form, in particular deeper customization of the character's head appearance via corresponding actuators. This may include glasses, brows, and/or nose lips 025.

Referring to FIG. 7B, an example is shown of a graphical object in the form of gestures (instead of a character) for customization according to an embodiment of the present invention. Features similar to those of a character may be selected and applied to the gestures (e.g., style, skin tone, accessories, body part, etc.).

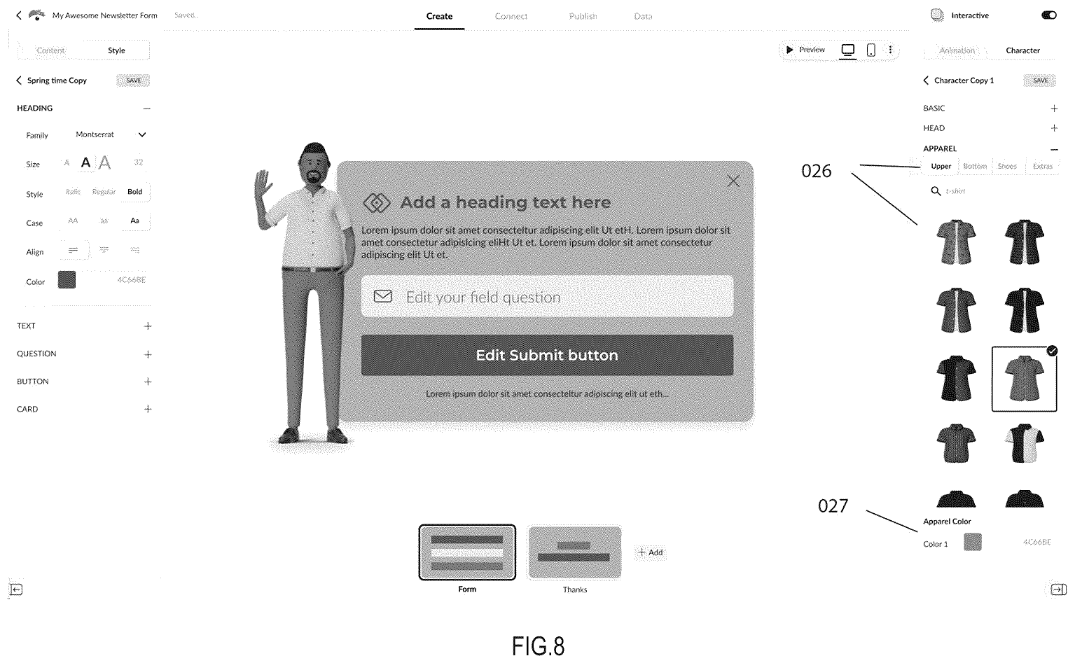

Referring to FIG. 8, an example is shown of another dialog screen or user interface of configuring a form, in particular deeper customization of the graphical object via corresponding actuators. For example, in the case of a character, the deeper customization may include clothing 026 and clothing color 027.

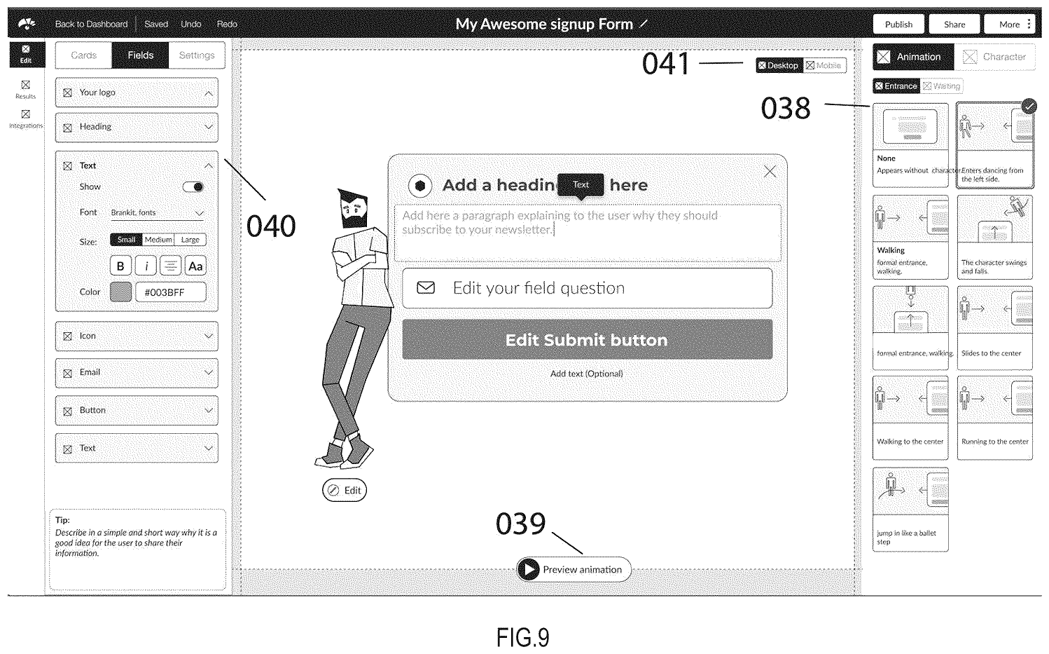

Referring to FIG. 9, an example is shown of another dialog screen or user interface of configuring a form, in particular, an animation of an appearance and interaction of a graphical object with a form via corresponding actuators. A customer can select an animation from an animation library 038, both for viewing in the application on mobile devices and in a computer browser 041. The system allows previewing of the selected animation from the animation library (and/or animated form) via actuator 039 (e.g., in real-time during customization), as well as more deeply customizing form fields 040. Further, characteristics of the animation may be modified according to user selection (e.g., speed of the animation, timing of the animation, sequence of animation steps, etc.).

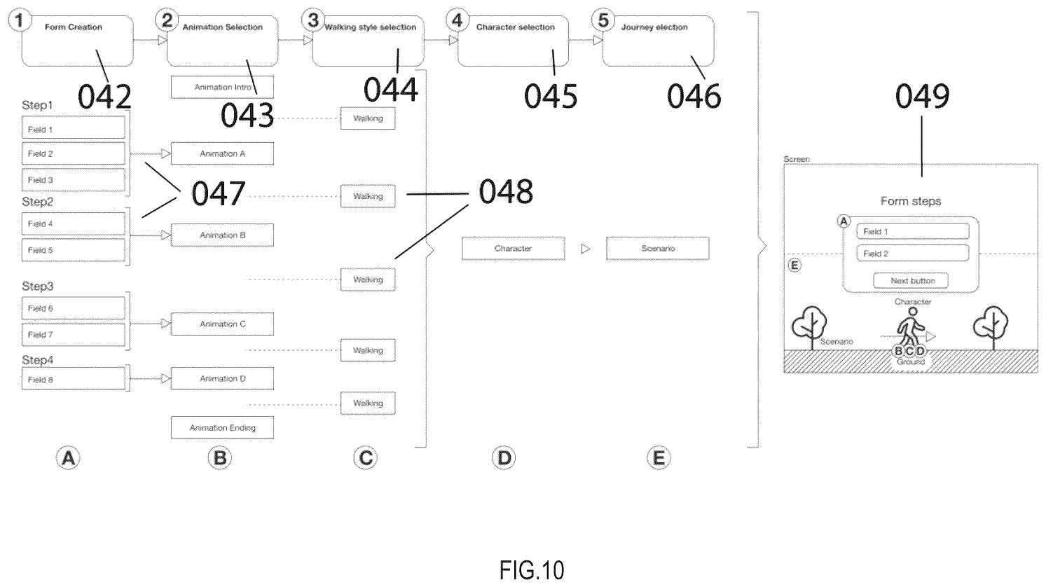

Referring to FIG. 10, an example is shown of form creation logic with advanced animation. The entire process of form creation in a form creation tool with advanced animation can include the following stages or operations: the user creates the form and defines the animation steps and fields at operation 042; for each animation step 047, the user can choose from a gallery of animations (actions) at operation 043; the user can choose the type of walking between animation steps at operation 044; walking animation at operation 048; the user can choose a character or create a new custom character at operation 045; the user can choose between several scenarios where the action occurred at operation 046. The result will be presented as a customized animated form 049 according to a given scenario.

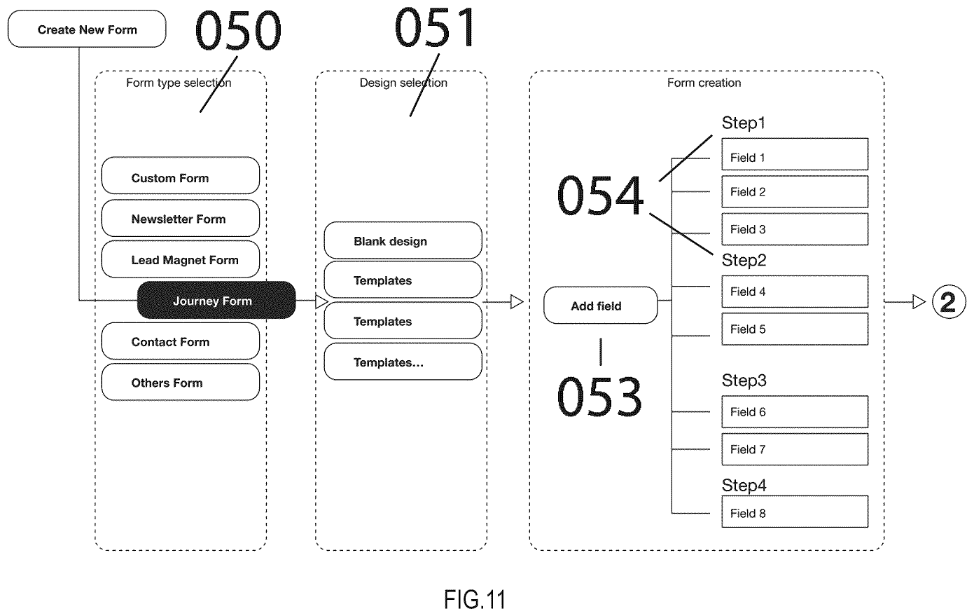

Referring to FIG. 11, an example is shown of a process of creating a new form with advanced animation. The process begins by selecting the type of form to be created, among other options at operation 050. The design of a form with advanced animation can be created or selected from proposed templates at operation 051. The templates may include information for an initial layout of the form (e.g., fields, animation, font, style, color, etc.) that may be modified as described below. The templates may be identified or found from a search based on keywords and/or categories. The user can add fields to fill in the form with advanced animation at operation 053. Each set of fields created in this way forms the animation steps in a resulting created form at operation 054.

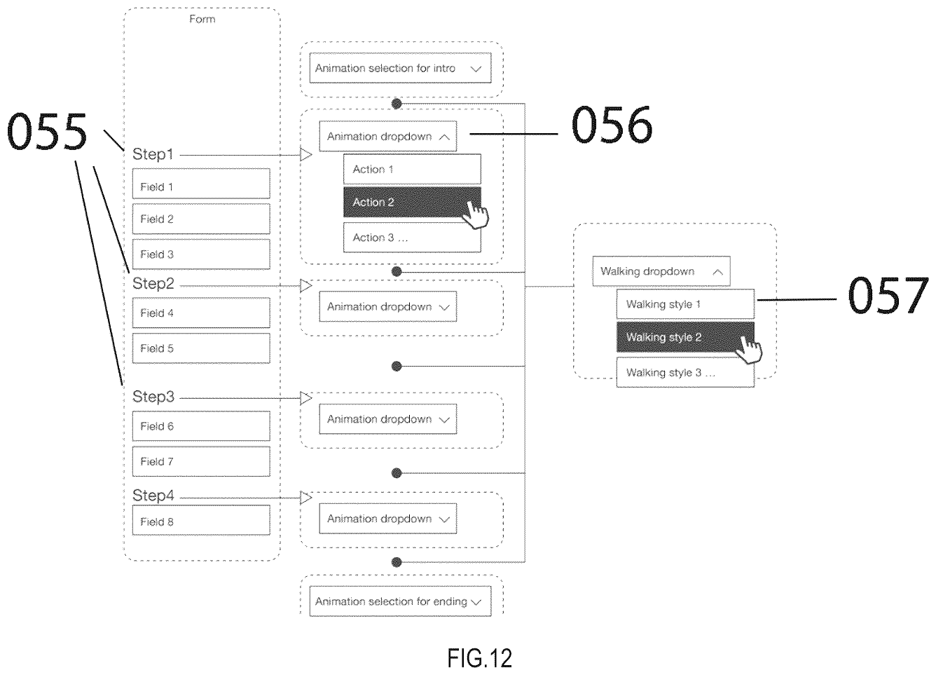

Referring to FIG. 12, an example is shown of a process of selecting an animation at operation 056 for each of animation steps 055 that make up a form with advanced animation. A walking style selected at operation 057 for the entire walking animation is shown between steps (actions) of the form with advanced animation.

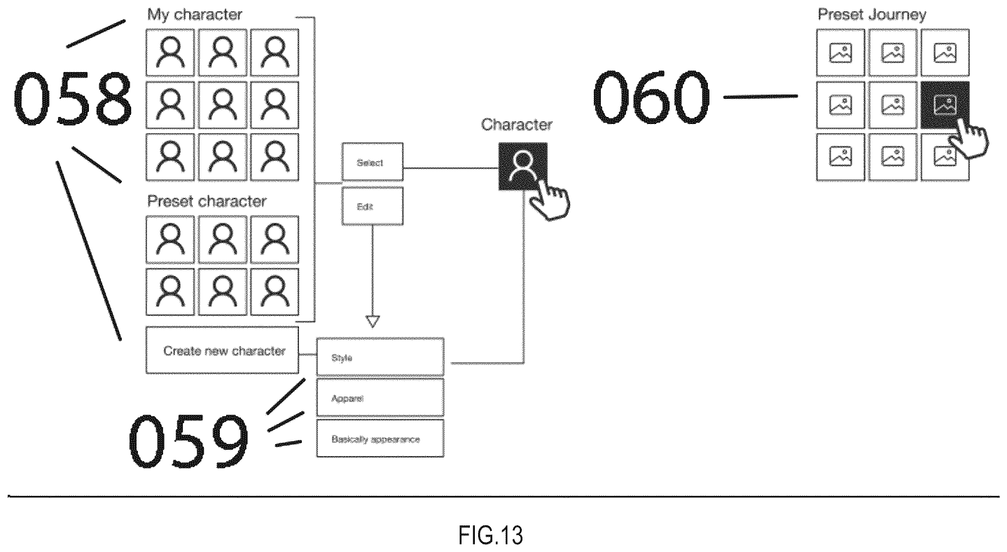

Referring to FIG. 13, an example is shown of a process of choosing a character. This can be a user character, a character template, or creation of a new character at operation 058. The selected character can be customized, where style, apparel, and/or appearance can be changed at operation 059. The scenario for a form with advanced animation can be selected from a presets list at operation 060.

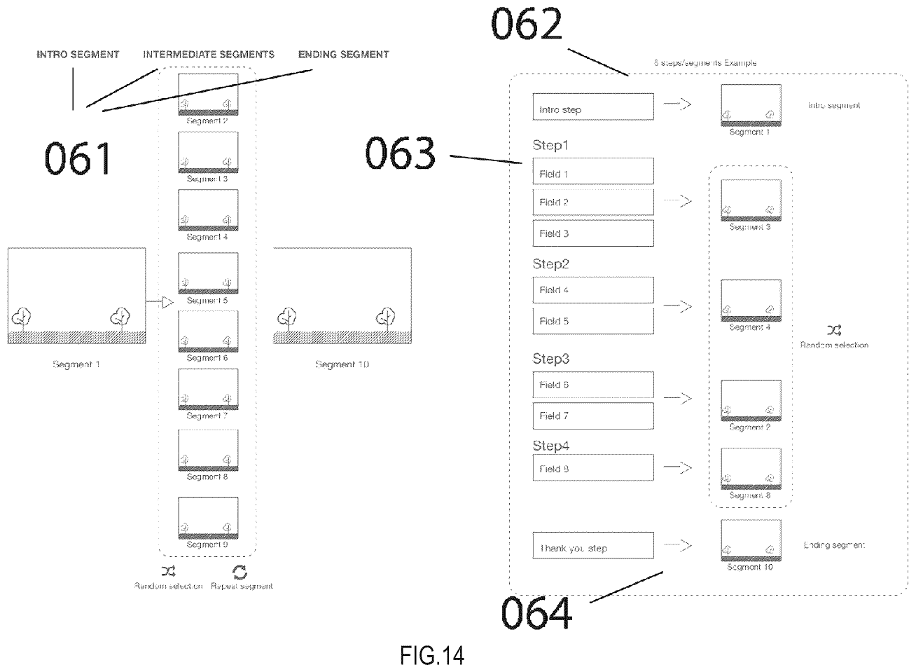

Referring to FIG. 14, an example is shown of a process of setting up a configuration of a form with advanced animation. The form may include an intro segment, one or more intermediate segments, and an ending segment 061, which are preferably sequential. During the process of creation of a form with advanced animation, segments will be assigned to corresponding animation steps. The intro segment will be assigned to an intro step at operation 062, intermediate segments will be assigned to one or more intermediate steps at operation 063, and the ending segment will be assigned to a final step at operation 064.

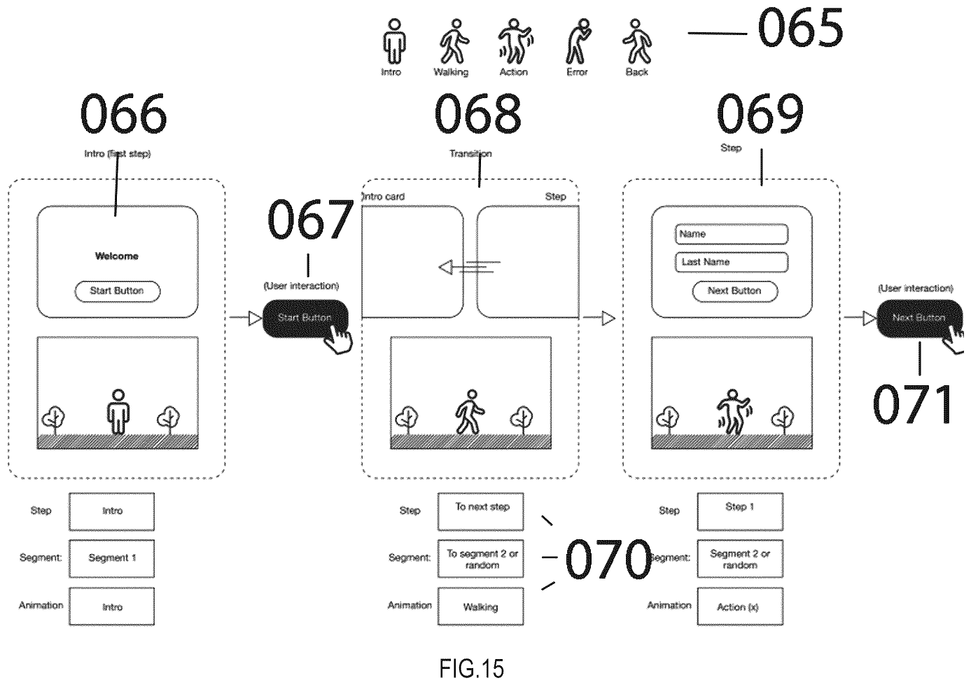

Referring to FIG. 15, an example is shown of a scenario outline or script for a form with advanced animation. Various character behavior options will be available for the user to select. These may include intro, walking, action, error, and/or back. A script begins with the first step or behavior, intro, at operation 066. After the user presses the button to start filling out the form at operation 067, a transition process will occur at operation 068 to a next operation 069, according to specified parameters 070. After a user fills out fields at operation 069, the user presses the next button at operation 071, to continue execution of the script of the form with advanced animation.

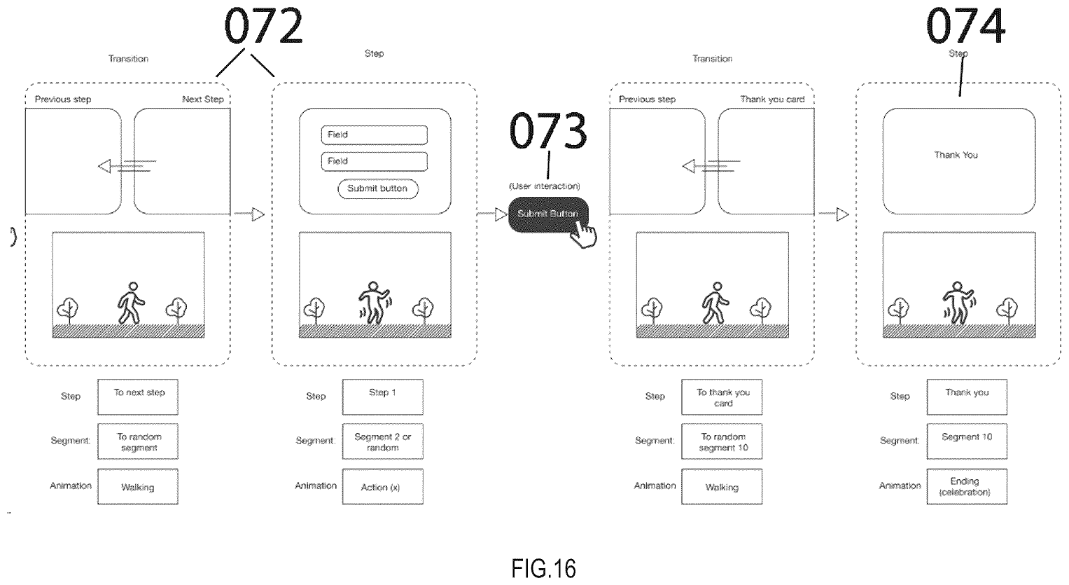

Referring to FIG. 16, an example is shown of a continuation scenario outline or script of a form with advanced animation. A form with advanced animation can contain a large number of intermediate steps and transitions 072. After completing the intermediate steps, a user clicks a submit button at operation 073, where the user is taken to the final step of the form with advanced animation at operation 074.

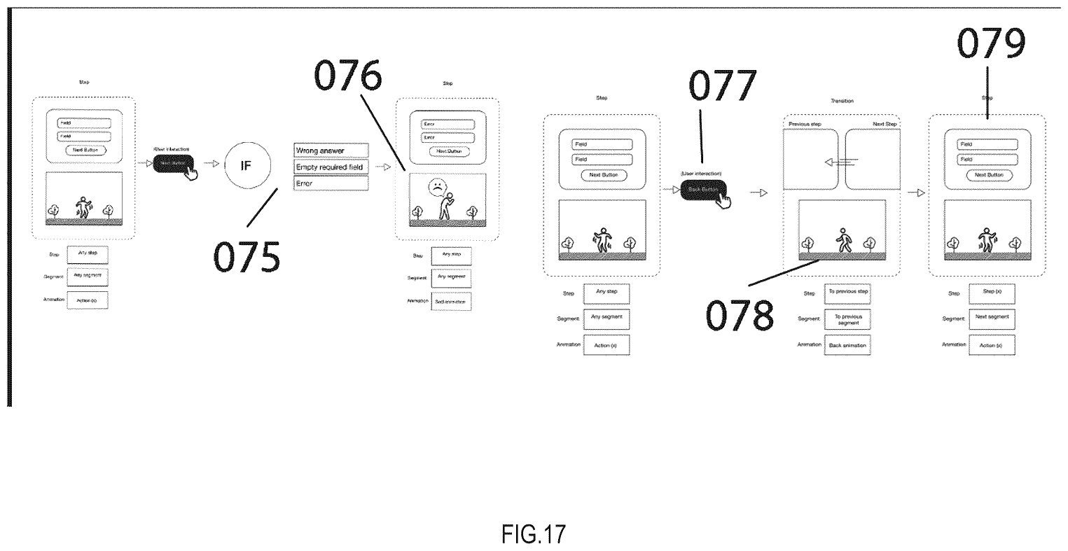

Referring to FIG. 17, an example is shown of additional scenarios or logic for filling out a form with advanced animation, for example, in the case of error or step back. For example, a step error 075 may be specified where a corresponding animation 076 will be triggered when the user enters the wrong answer or a reserved field is empty. By way of further example, a step back operation 079 may be specified, where a corresponding animation 078 will be played when the user presses a back button at operation 077 at any stage of filling out the form with advanced animation.

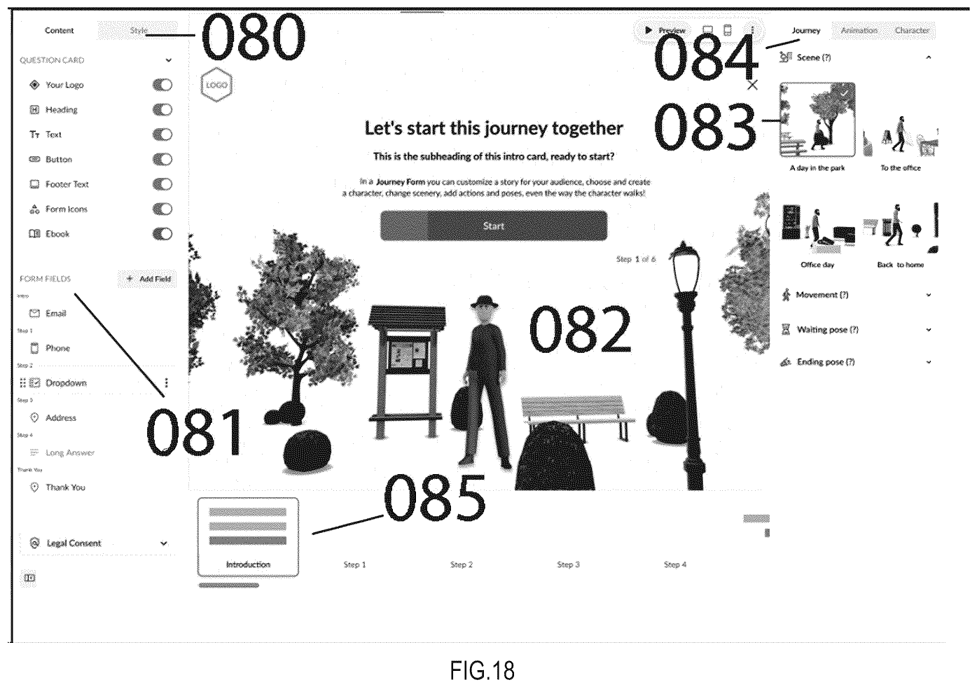

Referring to FIG. 18, an example is shown of a user interface for creating a form with advanced animation. The user interface allows the user to select customization objects via corresponding actuators. This may be, for example, setting content or style 080. By customizing the content of the form, the user can edit a number of fields to fill out for each step 081. All changes can be visible immediately in a preview window 082. Various scene templates 083 are available to the user to select for the form with advanced animation. The user interface of the advanced form creation tool allows the user to select scene templates, animation, and customize a character 084 for every step 085.

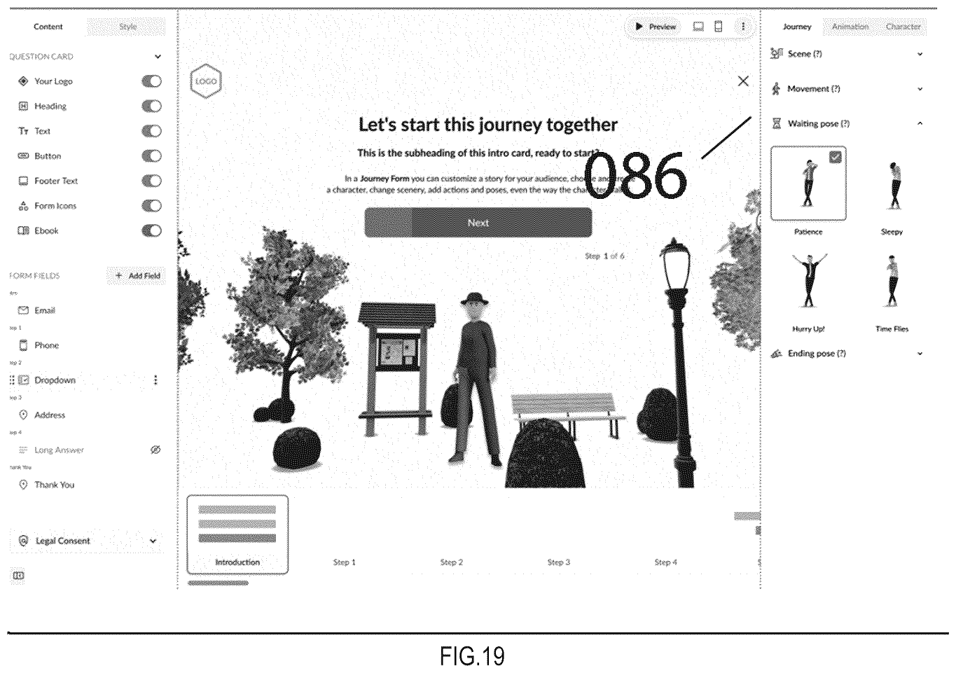

Referring to FIG. 19, an example is shown of the user interface for creating a form with advanced animation. By customizing content of a form, a user can choose movement, a waiting pose, and an ending pose 086 via corresponding actuators for every step of the proposed animations.

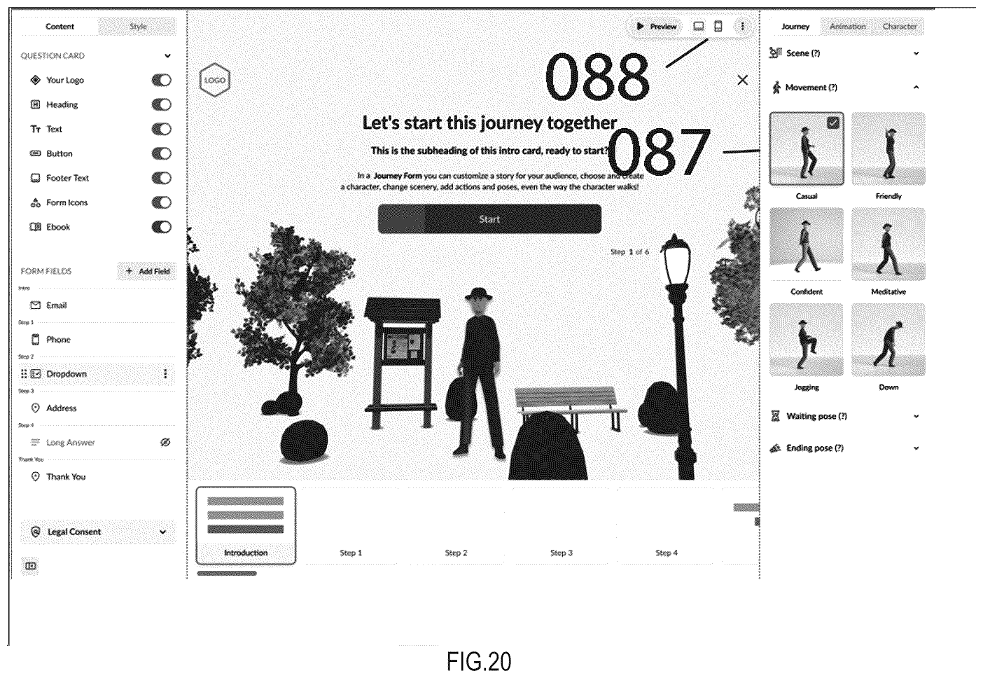

Referring to FIG. 20, an example is shown of the user interface for creating a form with advanced animation. The user interface of the advanced form creation tool allows users to preview the form via a corresponding actuator in a desktop or mobile version 088, and allows them to choose a movement animation (e.g., casual, friendly, confident, meditative, jumping, down, etc.) for each step 087 via corresponding actuators.

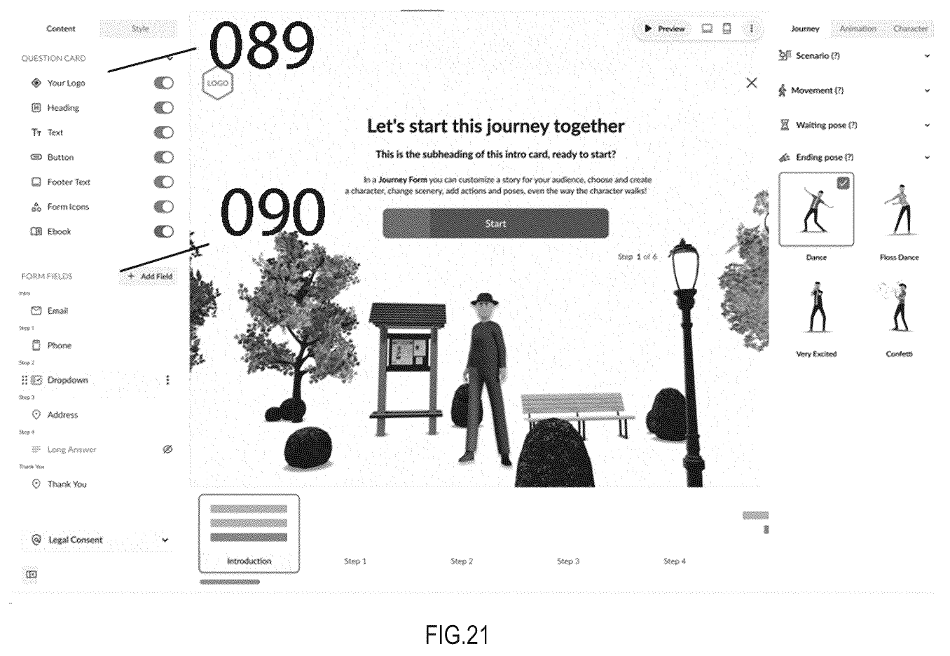

Referring to FIG. 21, an example is shown of the user interface for creating a form with advanced animation. The user interface of the advanced form creation tool allows the user to customize content of the form via corresponding actuators, for example, add a logo, heading, text, button, footer text, and/or form icons 089, and also customize form fields, such as email, phone, address, or thank you page 090.

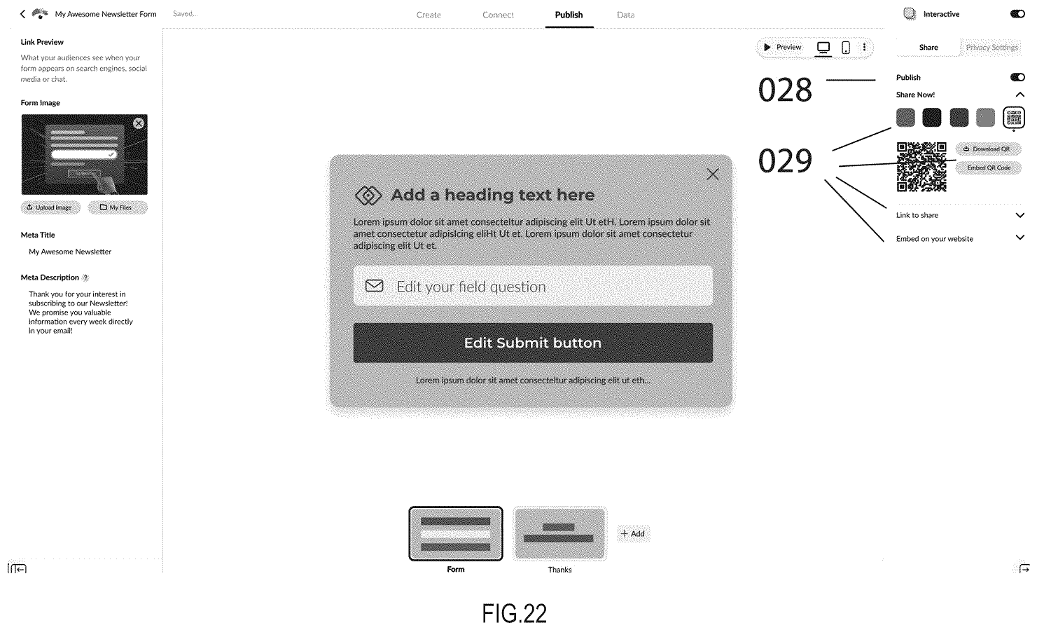

Referring to FIG. 22, an example is shown of a dialog screen or user interface for configuring a form via corresponding actuators including publication 028 and sharing 029. The code generation module allows sharing a link to the form, including, but not limited to, social networks and messengers, generating a QR code, and embedding the link and/or QR code in websites or forums.

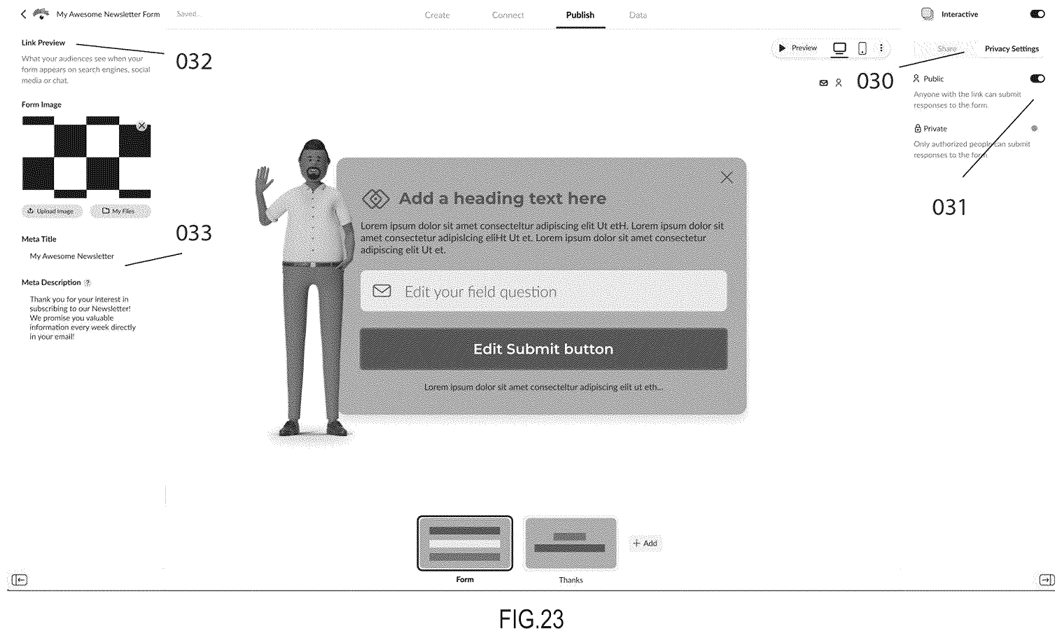

Referring to FIG. 23, an example is shown of a dialog screen or user interface for configuring a form via corresponding actuators including privacy parameters 030. The form can have characteristics of public and private 031. The preview module of the system generates a preview 032 that allows one to see how the link to the form will look, as well as see the form's metadata 033.

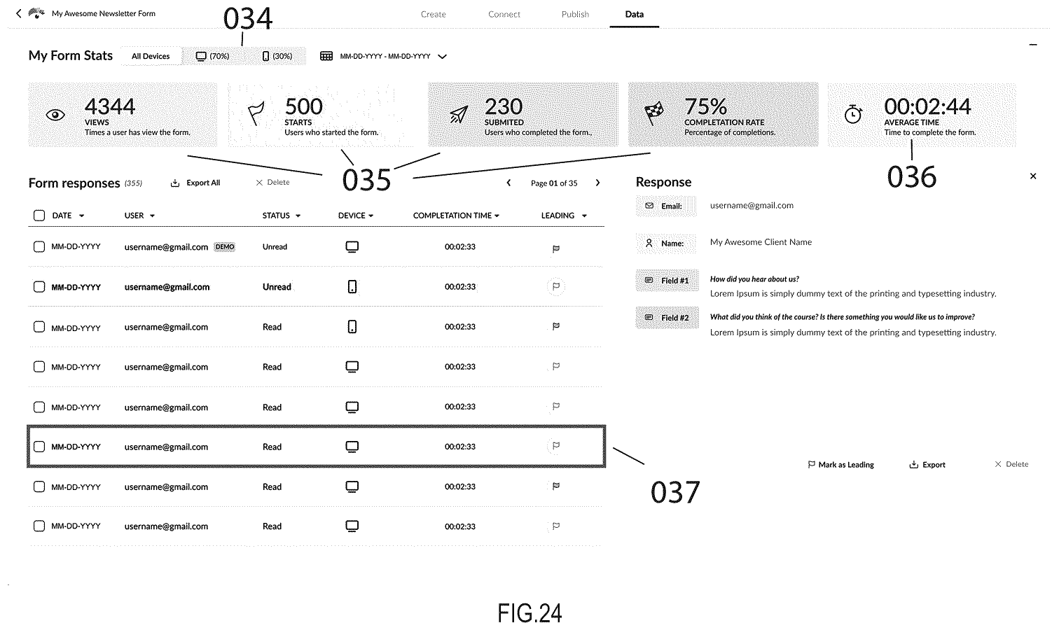

Referring to FIG. 24, an example is shown of a form statistics or metrics window. A system analytics module tracks and provides the customer with published form statistics or metrics. In particular, it allows one to track (e.g., in real-time) performance metrics or parameters (e.g., pertaining to conversion rates and user engagement), such as: the percentage of interaction with the form on a mobile device through an application and a computer through a browser 034; the times a user has viewed the form, the number of users who started the form and who completed the form, and/or percentage of completions 035; time to complete the form 036; and/or the date of completion, user email, status, the device from which the form was filled, and/or completion time 037.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any type of monitor and input device (e.g., keyboard, mouse, voice recognition, etc.) to enter and/or view information.

It is to be understood that the software of the present invention embodiments (e.g., modules 1001 and other software to perform the functions of present invention embodiments described herein) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts or flow diagrams may be modified in any manner that accomplishes the functions described herein. In addition, the functions in the flowcharts (or flow diagrams) or description may be performed in any order that accomplishes a desired operation.

The software of the present invention embodiments (e.g., modules 1001 and other software to perform the functions of present invention embodiments described herein) may be available on one or more non-transitory computer useable or readable mediums or media (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The embodiments of the present invention provide several technical advantages. For example, present invention embodiments generate custom animations and integrate the animations with web or other electronic or computerized forms to produce an animated form for interaction with a user. Animation features are customized, where selected features are integrated into or overlayed as individual or combined layers on a character or object skeleton to produce the animation. In addition, the forms are customized based on selected attributes and coordinated with the animation for interaction with the user. This reduces interaction or processing time since fewer errors are produced and form input is provided faster with reduced idle time for the processor.

In one example, an embodiment includes a system for creating customized forms with animation. The system comprises a memory and one or more processors coupled to the memory. The one or more processors select pre-made templates of animated forms. The animated forms include animated graphical objects. The animation of selected pre-made templates is customized, including adjusting the speed, timing, and sequence of animation steps, various animated poses, and gestures. A layout of one or more of the animated forms is customized, including adding, removing, or rearranging form fields and adjusting colors, fonts, and styles of the one or more forms. Embeddable code for the customized animated forms is generated.

In one example, the one or more processors are further configured to customize a sequence and timing of individual animation steps.

In one example, the one or more processors are further configured to display an animated form in real-time during customization.

In one example, the one or more processors are further configured to find pre-made templates based on keywords or categories.

In one example, the one or more processors are further configured to track performance of the animated forms, including conversion rates and user engagement metrics.

In one example, a system for generating forms with animation is provided. The system comprises one or more memories, and one or more processors coupled to the one or memories and configured to: identify a template of an animated form, wherein the animated form includes one or more fields to receive information and one or more animated graphical objects directing entry of the information into the one or more fields; customize the animated form of the template according to user selections by modifying at least one characteristic of animation of the one or more animated graphical objects of the animated form of the template; and generate computer code for presenting the animated form.

In one example, the at least one characteristic includes one or more from a group of speed of the animation, timing of the animation, sequence of animation steps, animated poses, and animated gestures.

In one example, customizing the animated form further comprises customizing a layout of the animated form, including one or more from a group of adding, removing, or rearranging the one or more fields, and adjusting at least one from a group of colors, fonts, and styles of the animated form.

In one example, the one or more processors are further configured to display the animated form in real-time during customization.

In one example, the animated form includes a plurality of sequential animated segments, and customizing the animated form further comprises generating an animation including at least one animated graphical object performing an action for each animated segment in accordance with the user selections.

In one example, customizing the animated form further comprises generating a corresponding animation for presentation in response to one of occurrence of an error during completion of the animated form and a request to return to a prior segment.

In one example, the one or more processors are further configured to track performance metrics of the animated form, wherein the performance metrics include conversion rates and user engagement metrics.

In one example, a method of generating forms with animation is provided. The method comprises: identifying, via at least one processor, a template of an animated form, wherein the animated form includes one or more fields to receive information and one or more animated graphical objects directing entry of the information into the one or more fields; customizing, via the at least one processor, the animated form of the template according to user selections by modifying at least one characteristic of animation of the one or more animated graphical objects of the animated form of the template; and generating, via the at least one processor, computer code for presenting the animated form.

In one example of the method, the at least one characteristic includes one or more from a group of speed of the animation, timing of the animation, sequence of animation steps, animated poses, and animated gestures.

In one example of the method, customizing the animated form further comprises customizing a layout of the animated form, including one or more from a group of adding, removing, or rearranging the one or more fields, and adjusting at least one from a group of colors, fonts, and styles of the animated form.

In one example, the method further comprises displaying, via the at least one processor, the animated form in real-time during customization.

In one example of the method, the animated form includes a plurality of sequential animated segments, and customizing the animated form further comprises generating an animation including at least one animated graphical object performing an action for each animated segment in accordance with the user selections.

In one example of the method, customizing the animated form further comprises generating a corresponding animation for presentation in response to one of occurrence of an error during completion of the animated form and a request to return to a prior segment.

In one example, the method further comprises tracking, via the at least one processor, performance metrics of the animated form, wherein the performance metrics include conversion rates and user engagement metrics.

In one example, a computer program product for generating forms with animation is provided. The computer program product comprises one or more non-transitory computer readable media having program instructions stored thereon, the program instructions executable by at least one processor to cause the at least one processor to: identify a template of an animated form, wherein the animated form includes one or more fields to receive information and one or more animated graphical objects directing entry of the information into the one or more fields; customize the animated form of the template according to user selections by modifying at least one characteristic of animation of the one or more animated graphical objects of the animated form of the template; and generate computer code for presenting the animated form.

In one example of the computer program product, the at least one characteristic includes one or more from a group of speed of the animation, timing of the animation, sequence of animation steps, animated poses, and animated gestures.

In one example of the computer program product, customizing the animated form further comprises customizing a layout of the animated form, including one or more from a group of adding, removing, or rearranging the one or more fields, and adjusting at least one from a group of colors, fonts, and styles of the animated form.

In one example, the program instructions further cause the at least one processor to display the animated form in real-time during customization.

In one example of the computer program product, the animated form includes a plurality of sequential animated segments, and customizing the animated form further comprises generating an animation including at least one animated graphical object performing an action for each animated segment in accordance with the user selections.

In one example of the computer program product, customizing the animated form further comprises generating a corresponding animation for presentation in response to one of occurrence of an error during completion of the animated form and a request to return to a prior segment.

In one example, the program instructions further cause the at least one processor to track performance metrics of the animated form, wherein the performance metrics include conversion rates and user engagement metrics.

While embodiments of the present invention have been described in terms of particular embodiments and applications, in both summarized and detailed forms, it is not intended that these descriptions in any way limit its scope to any such embodiments and applications, and it will be understood that many substitutions, changes, and variations in the described embodiments, applications and details of the method, system, and computer program product illustrated herein and of their operation can be made by those skilled in the art without departing from the spirit of this invention.

What is claimed is:

1. A system for generating forms with animation comprising:
one or more memories; and
one or more processors coupled to the one or memories and configured to:
identify a template of an animated form, wherein the animated form includes one or more fields to receive information and one or more animated graphical objects directing entry of the information into the one or more fields;
customize the animated form of the template according to user selections by modifying at least one characteristic of animation of the one or more animated graphical objects of the animated form of the template; and
generate computer code for presenting the animated form.

2. The system of claim 1, wherein the at least one characteristic includes one or more from a group of speed of the animation, timing of the animation, sequence of animation steps, animated poses, and animated gestures.

3. The system of claim 1, wherein customizing the animated form further comprises:
customizing a layout of the animated form, including one or more from a group of adding, removing, or rearranging the one or more fields, and adjusting at least one from a group of colors, fonts, and styles of the animated form.

4. The system of claim 1, wherein the one or more processors are further configured to:
display the animated form in real-time during customization.

5. The system of claim 1, wherein the animated form includes a plurality of sequential animated segments, and customizing the animated form further comprises:
generating an animation including at least one animated graphical object performing an action for each animated segment in accordance with the user selections.

6. The system of claim 5, wherein customizing the animated form further comprises:
generating a corresponding animation for presentation in response to one of occurrence of an error during completion of the animated form and a request to return to a prior segment.

7. The system of claim 1, wherein the one or more processors are further configured to:
track performance metrics of the animated form, wherein the performance metrics include conversion rates and user engagement metrics.

8. A method of generating forms with animation comprising:
identifying, via at least one processor, a template of an animated form, wherein the animated form includes one or more fields to receive information and one or more animated graphical objects directing entry of the information into the one or more fields;
customizing, via the at least one processor, the animated form of the template according to user selections by modifying at least one characteristic of animation of the one or more animated graphical objects of the animated form of the template; and
generating, via the at least one processor, computer code for presenting the animated form.

9. The method of claim 8, wherein the at least one characteristic includes one or more from a group of speed of the animation, timing of the animation, sequence of animation steps, animated poses, and animated gestures.

10. The method of claim 8, wherein customizing the animated form further comprises:
customizing a layout of the animated form, including one or more from a group of adding, removing, or rearranging the one or more fields, and adjusting at least one from a group of colors, fonts, and styles of the animated form.

11. The method of claim 8, further comprising:
displaying, via the at least one processor, the animated form in real-time during customization.

12. The method of claim 8, wherein the animated form includes a plurality of sequential animated segments, and customizing the animated form further comprises:
generating an animation including at least one animated graphical object performing an action for each animated segment in accordance with the user selections.

13. The method of claim 12, wherein customizing the animated form further comprises:
generating a corresponding animation for presentation in response to one of occurrence of an error during completion of the animated form and a request to return to a prior segment.

14. The method of claim 8, further comprising:
tracking, via the at least one processor, performance metrics of the animated form, wherein the performance metrics include conversion rates and user engagement metrics.

15. A computer program product for generating forms with animation, the computer program product comprising one or more non-transitory computer readable media having program instructions stored thereon, the program instructions executable by at least one processor to cause the at least one processor to:
identify a template of an animated form, wherein the animated form includes one or more fields to receive information and one or more animated graphical objects directing entry of the information into the one or more fields;
customize the animated form of the template according to user selections by modifying at least one characteristic of animation of the one or more animated graphical objects of the animated form of the template; and
generate computer code for presenting the animated form.

16. The computer program product of claim 15, wherein the at least one characteristic includes one or more from a group of speed of the animation, timing of the animation, sequence of animation steps, animated poses, and animated gestures.

17. The computer program product of claim 15, wherein customizing the animated form further comprises:
customizing a layout of the animated form, including one or more from a group of adding, removing, or rearranging the one or more fields, and adjusting at least one from a group of colors, fonts, and styles of the animated form.

18. The computer program product of claim 15, wherein the program instructions further cause the at least one processor to:
display the animated form in real-time during customization.

19. The computer program product of claim 15, wherein the animated form includes a plurality of sequential animated segments, and customizing the animated form further comprises:
generating an animation including at least one animated graphical object performing an action for each animated segment in accordance with the user selections.

20. The computer program product of claim 19, wherein customizing the animated form further comprises:
generating a corresponding animation for presentation in response to one of occurrence of an error during completion of the animated form and a request to return to a prior segment.

21. The computer program product of claim 15, wherein the program instructions further cause the at least one processor to:
track performance metrics of the animated form, wherein the performance metrics include conversion rates and user engagement metrics.
